(19) United States
(12) Patent Application Publication
(10) Pub. No.: US 2011/0181187 A1
(43) Pub. Date: Jul. 28, 2011

(54) QUICK-START FOR LOW-PRESSURE MERCURY AMALGAM LAMPS

(75) Inventors: Alex Voronov, Hanau (DE); Karsten Ernesti, Hanau (DE)

(73) Assignee: HERAEUS NOBLELIGHT GMBH, Hanau (DE)

(21) Appl. No.: 13/003,610

(22) PCT Filed: Jun. 30, 2009
(86) PCT No.: PCT/EP09/04692

§ 371 Date: Mar. 31, 2011

(30) Foreign Application Priority Data
Jul. 11, 2008 (DE) 10 2008 032 608.9

(51) Int. Cl. H01J 61/52; H01J 17/26

(52) U.S. Cl. 315/112; 313/563

(57) ABSTRACT

A method is provided for operating an amalgam lamp, wherein the amalgam lamp has an emitter tube filled with inert gas. The amalgam is heated in the emitter tube by an external energy source. The amalgam lamp has an amalgam deposit.

### CROSS-REFERENCE TO RELATED APPLICATIONS

This application is a section 371 of International Application No. PCT/EP2009/004692, filed Jun. 30, 2009, which was published in the German language on Jan. 14, 2010 under International Publication No. WO 2010/003570 A1 and the disclosure of which is incorporated herein by reference.

### BACKGROUND OF THE INVENTION

The invention relates to a method for the operation of an amalgam lamp, wherein the start-up time is reduced.

Amalgam lamps are extremely long-lived, high-power, low-pressure lamps. They achieve up to 10-times the UV power density of classical low-pressure mercury lamps and can be used at higher ambient temperatures. In addition, amalgam lamps are not sensitive to temperature fluctuations.

Typical fields of use for amalgam lamps are, among others, drinking-water sterilization and service-water conditioning in industry, water sterilization in fish farming, but also disinfection of air in air-conditioning and cooling systems and surface disinfection.

However, such lamps require a few minutes to reach full power, because mercury is normally bound in the solid amalgam before and shortly after ignition. Just the heating by the inert-gas discharge brings the mercury into the gaseous phase, so that a significant arc-drop voltage and thus lamp output is set. Therefore, such lamps require a few minutes until they develop their full effect.

In order to realize a quick start in low-pressure mercury amalgam lamps, it is not sufficient only to significantly increase the discharge current relative to the operating current. In these lamps, the greatest part of the mercury is bound in the amalgam in the cold state. Therefore, it is necessary to heat the amalgam deposit selectively, so that in this way a significant mercury-vapor pressure can build up quickly within the lamp.

In German Patent DE 102 01 617 B4, for influencing the temperature of the amalgam, a heating element deposited on the lamp is provided in the form of a PTC or an ohmic resistor. The heat transfer through the quartz to the amalgam is here, however, rather slow. Furthermore, the heating element is provided here for controlling the amalgam temperature during the operation, not for achieving a short firing time.

### BRIEF SUMMARY OF THE INVENTION

The object of the invention is therefore to provide a method for the operation of an amalgam lamp, in which the start-up time is significantly reduced and the lamp develops its full effect after just a few seconds, as well as to provide an amalgam lamp suitable for the method.

This object is achieved by an amalgam lamp and a method for the operation of an amalgam lamp, wherein the amalgam lamp has an emitter tube filled with inert gas, and wherein the amalgam in the emitter tube is heated by an external energy source.

The method according to the invention for the operation of an amalgam lamp, wherein the amalgam lamp has at least one amalgam deposit, provides that the deposit is heated by an external energy source. Through this heating, the amalgam is caused to liquefy within one second, so that a significant mercury-vapor pressure builds up quickly and the lamp comes to full power quickly after ignition. Consequently, the firing phase decreases to a few seconds. It has been shown that this quick-start behavior is very important, especially for technical processes in which a discontinuous operation is desired and firing phases of less than 10 seconds are desired.

In one advantageous embodiment, the invention provides that an infrared lamp is used as the energy source. Here, the infrared lamp has a gold-plated reflector.

The infrared lamp is similar to a conventional halogen reflector lamp for general illumination. The spiral-wound filament is focused on a focal spot of a few millimeters diameter. The infrared reflector lamp is arranged above the amalgam lamp, so that the focal spot is brought into convergence with the amalgam deposit. Therefore, the amalgam is liquefied within one second after turning on the infrared reflector lamp, and the desired mercury-vapor pressure builds up, so that the lamp can quickly emit its full power.

The amalgam lamp according to the invention provides a lamp tube filled with inert gas and having two electrodes arranged in the lamp tube, wherein on one side of the lamp tube at least one amalgam deposit is arranged.

Between the quartz tube and the amalgam deposit, an adhesive layer, for example made of precious metal, can be deposited. The adhesive layer is advantageously used as a carrier layer for amalgam.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic representation of a low-pressure mercury amalgam lamp according to an embodiment of the invention having an external energy source.

FIG. 2 is a graphical presentation of the start-up behavior of a conventional low-pressure mercury amalgam lamp, plotting UV power versus time (t) in seconds.

FIG. 3 is a graphical presentation of the start-up behavior of a low-pressure mercury amalgam lamp according to an embodiment of the invention, plotting UV power versus time (t) in seconds.

### DETAILED DESCRIPTION OF THE INVENTION

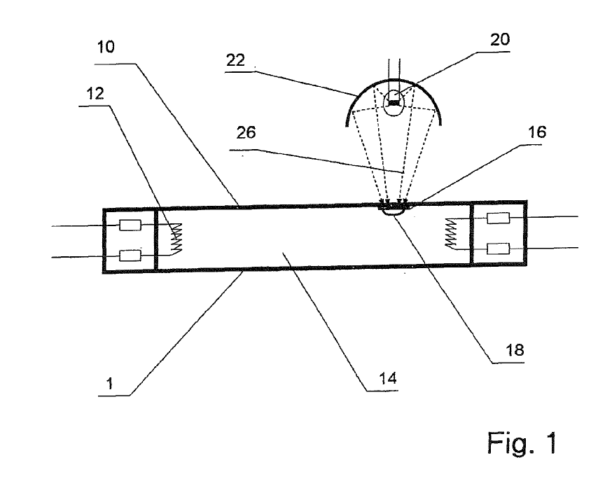

In FIG. 1 a low-pressure mercury amalgam lamp 1 is shown, which has a lamp tube 10 with two electrodes 12 arranged in the lamp tube 10. The inner space 14 of the lamp 1 is filled with an inert gas or inert-gas mixture. Here, the lamp tube 10 seals the inner space 14 from the surroundings. On the inner side of the lamp tube 10, there is optionally an adhesive layer 16, which is formed in this case from gold or a gold alloy. This adhesive layer 16 is used as a carrier for the amalgam deposit 18. An external infrared lamp 20 having a reflector 22 is arranged next to the amalgam deposit 18, so that the infrared radiation 26 is focused onto the amalgam deposit 18. Before the ignition of the lamp 1, the amalgam deposit 18 is now heated and therefore releases mercury vapor. This is already available for the discharge during ignition, so that a significant UV power is set immediately.

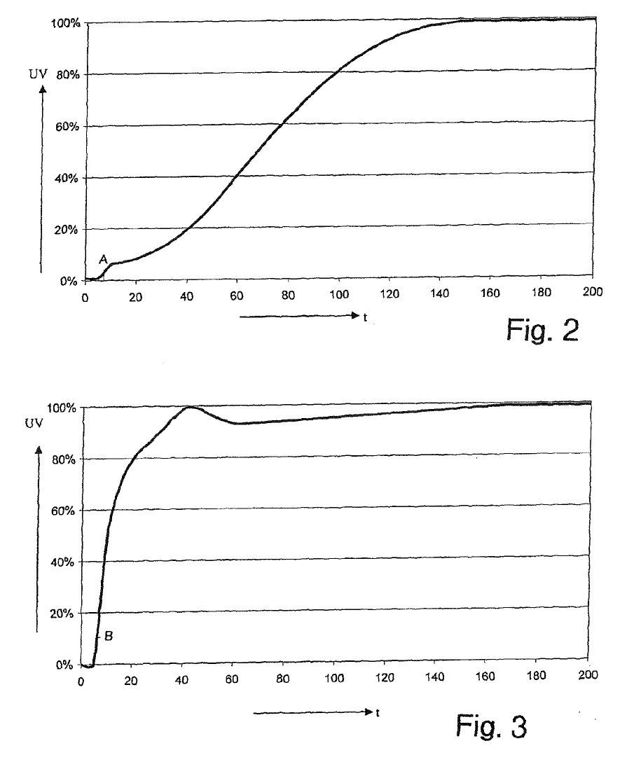

In FIG. 2 the start-up behavior of a conventional low-pressure mercury amalgam lamp without amalgam heating is shown. Here, as shown for example in FIG. 1, the electrodes are pre-heated by a heating current and after approximately 5 seconds, at time A, the lamp is ignited. It is clear to see that the UV power at the beginning is extremely low and rises only slowly. Only after approximately 70 seconds has the lamp reached approximately 50% of the UV power, and approximately 140 seconds elapses until the low-pressure mercury amalgam lamp reaches its full UV power.

FIG. 3 shows the start-up behavior of a low-pressure mercury amalgam lamp according to an embodiment of the invention. Here, just as for conventional lamps, the electrodes are preheated for 5 seconds, but in addition, the amalgam deposit is also simultaneously preheated for the same time up to time B. It is clear to see that the low-pressure mercury amalgam lamp reaches approximately 50 percent of the UV power within approximately 10 seconds and reaches its full UV power after approximately 30 seconds.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-10. (canceled)

11. A method for operation of an amalgam lamp having an emitter tube containing an amalgam, the method comprising filling the emitter tube with inert gas, and heating the amalgam in the emitter tube by an external energy source.

12. The method according to claim 11, wherein the external energy source comprises an infrared lamp.

13. The method according to claim 12, wherein the infrared lamp has a gold-plated mirror.

14. The method according to claim 11, further comprising a step of turning on the external energy source before heating the amalgam.

15. The method according to claim 11, further comprising a step of turning off the external energy source after heating the amalgam.

16. An amalgam lamp for operation of the method according to claim 11.

17. The amalgam lamp according to claim 16, wherein the emitter tube has an amalgam deposit.

18. The amalgam lamp according to claim 17, wherein the amalgam lamp has an adhesive layer on an inner side of the emitter tube.

19. The amalgam lamp according to claim 18, wherein the amalgam deposit is arranged on the adhesive layer.

20. The amalgam lamp according to claim 18, wherein the adhesive layer comprises a precious metal.
